(19) United States
(12) Patent Application Publication
(10) Pub. No.: US 2006/0042175 A1
(43) Pub. Date: Mar. 2, 2006

(54) Cable carrier chain arrangement in ascending vertical position inserted in telescopic groups with two or more sections

(75) Inventor: Gilberto Crespi, Magnago (Milan) (IT)

Correspondence Address: HEDMAN & COSTIGAN P.C., 1185 AVENUE OF THE AMERICAS, NEW YORK, NY, 10036, US

(73) Assignee: Kabelschlepp Italia S.r.l.

(21) Appl. No.: 11/206,715

(22) Filed: Aug. 18, 2005

(30) Foreign Application Priority Data
Sep. 2, 2004 (IT) MI2004U 000405

(51) Int. Cl. E04H 12/18; F16L 3/01

(52) U.S. Cl. 52/111; 248/49

(57) ABSTRACT

An improved cable carrier chain arrangement (11) in ascending vertical position inserted in telescopic groups (12) with two or more sections that contains and guides flexible pipings or similar, in which it is foreseen that the cable carrier chain (11) has, at opposite ends, a first fixed point (13) , integral with a mobile section (14, 16, 17) of the telescopic group (12), and a second fixed point (18, 20), integral with a fixed section (15) or with at least one mobile section (17) of the telescopic group, characterised where in the arrangement a tensioning retaining element (21) of the cable carrier chain is foreseen acting on the chain itself in whatever position of the mobile section (14) of the telescopic group on which the first fixed point (13) is arranged.

The present invention refers to an improved cable carrier chain arrangement in ascending vertical position inserted in telescopic groups with two or more sections.

In the field the generic term “cable-carrier” is used when one intends to indicate products such as cable carrier chains, open and/or closed or openable cable carrier sheaths, made from steel, polyamide, nylon and more generally other plastic or ferrous materials. These products defined as cable-carriers are suitable for containing and guiding generic flexible pipings or else energy conductors (water, electric current, transmission cables, gas, oil, etc.).

It is equally important to specify that cable carriers, when used to carry the aforementioned generic pipings upwards, are even more critical in their behaviour with bending and with combined bending and compressive stress. Indeed, cable-carriers in such a vertical position, in particular for lengths of around 10 metres, have a withdrawal that determines the possibility of bending. Consequently, they must be constructed with special self-supporting provisions suitable for ensuring correct use without any danger of breaking or yielding.

The purpose of the present invention is that of making an improved cable carrier chain arrangement in ascending vertical position inserted in telescopic groups with two or more sections that is such as to contain and guide flexible pipings and/or energy conductors, also for the great lengths indicated and at high temperatures.

Another purpose is that of making an improved cable carrier chain arrangement in ascending vertical position inserted in telescopic groups with two or more sections that has a not particularly complex structure. Yet another purpose of the present invention is that of making an improved cable carrier chain arrangement in ascending vertical position inserted in telescopic groups with two or more sections that is particularly simple and easy to construct and to actuate.

These purposes according to the present invention are accomplished by making an improved cable carrier chain arrangement in ascending vertical position inserted in telescopic groups with two or more sections as outlined in claim 1.

Further constructive characteristics emerge from the attached dependent claims.

The characteristics and advantages of an improved cable carrier chain arrangement in ascending vertical position inserted in telescopic groups with two or more sections according to the present invention shall become clearer from the following description, given as an example and not for limiting purposes, referring to the attached schematic drawings, in which:

FIG. 1 is a schematic side elevation view of a first example of a cable carrier chain in ascending vertical position inserted in telescopic groups with two or more sections according to the present invention, in withdrawn position and arranged in a telescopic group.

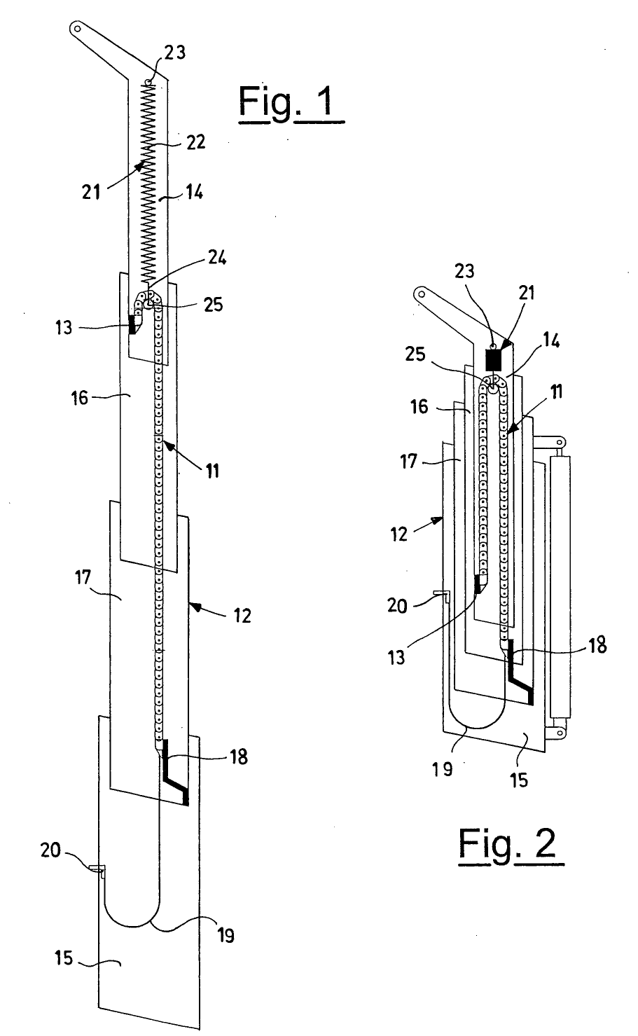

FIG. 2 is a side elevation view of the chain of FIG. 1 in withdrawn position.

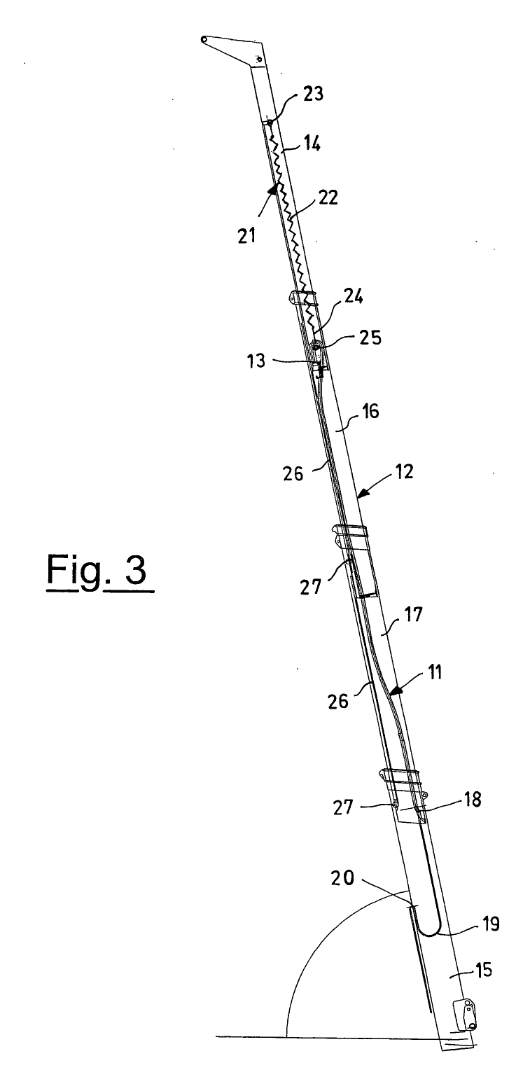

FIG. 3 is a schematic side elevation view of a second example of a cable carrier chain according to the present invention arranged in a telescopic group of a lifting device when in withdrawn ascending vertical position.

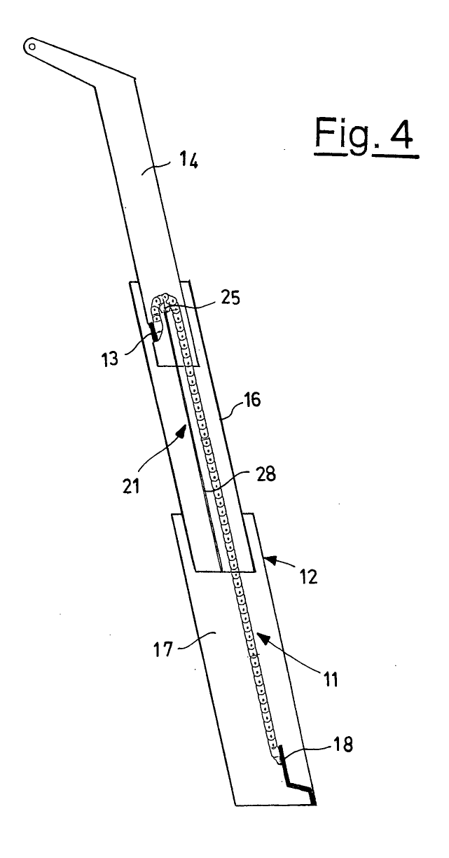

FIG. 4 is a schematic side elevation view of a third example of a cable carrier chain according to the present invention arranged in a telescopic group of a lifting device when in withdrawn and inclined ascending vertical position.

With reference to the figures, in general a cable carrier chain in ascending vertical position is shown, wholly indicated with 11, arranged in a telescopic group 12, with two or more fixed and mobile sections, like that of an aerial basket or aerial platform, a lifting device, a crane truck, a self-propelled lifting device, etc., able to be moved between an operative position inclined with either a positive or negative angle (from 90° up to minus 45° with respect to the horizontal) to contain and guide flexible pipings or similar auxiliary and power controls, not shown. The cable carrier chain 11 has a first end thereof connected to a fixed point 13 of a first extractable mobile section 14, where the fixed point 13 is foreseen in a lower zone in height in such a extractable section 14, when lowered towards a horizontal position of the telescopic group 12. The other end of the cable carrier chain 11, on the other hand, is arranged fixedly connected or guided in a brief portion thereof in a fixed section 15 acting as the base of the telescopic group 12. Indeed, this fixed section 15 together with the quoted mobile or extractable section 14 makes the quoted telescopic group 12, possibly with the interposition of further telescopic mobile sections 16, 17, as shown in FIGS. 1 and 2.

In the example of FIGS. 1 and 2 the quoted other end of the cable carrier chain 11 is fixed at 18 to a third extractable section 17 closer to the fixed section 15 and in this attachment 18 an arched flexible end portion 19 is also connected that extends from the cable carrier chain 11 and it is able to slide in the fixed section 15 to which it is fixed at 20 in an end curved downwards, when the group is in horizontal position.

FIGS. 1 and 2 show, as stated, a first example in which the four elements 14, 15, 16, 17 are in two withdrawn and extracted positions. It should be noted that the cable carrier chain 11, when the mobile and extractable elements 14, 16 and 17 are completely slotted into the fixed element 15, is arranged according to a U-shaped configuration rested on one side of the U. Of course, in an example in which just the extractable section 14 is present, in addition to the fixed section 15, the point 18 is that of final attachment of the second end of the chain 11 or coincides with the fixed point 20.

According to the invention, the improved cable carrier chain arrangement 11 is made, which assumes its correct position in the telescopic group 12, thanks to the presence of a tensioning retaining element 21 of the cable carrier chain 11. This tensioning retaining element 21 acts with more or less force, in any position of the at least one mobile extractable section 14 of the telescopic group 12, with respect to the fixed section 15 of the same group. In particular, in the example of FIGS. 1 and 2 it can be seen how the tensioning retaining element 21 comprises an elastic element, such as a cylinder, a linear actuator, any support with chains or cables and return elements, etc. acting suitably between the parts. In the example, a spring 22, fixedly connected at one end at 24 to the quoted mobile extractable section 14 of the telescopic group 12 and carrying a takeup pulley 25 free to rotate and support the chain 11 at the other end, is shown as tensioning retaining element.

FIG. 2 shows which position the cable carrier chain 11 assumes when the various extractable sections 14, 16, 17 are extracted from the fixed sections 15. The presence of the spring 22 that acts as tensioning retaining element 21 ensures constant and continuous support of the chain 11 preventing it yielding or breaking whatever the chain is made from. Indeed, in the example shown, the takeup pulley 25 collaborates with the spring 22 to support the chain also avoiding any type of friction that can be harmful to the integrity of the cable carrier chain 11.

Further examples are shown in which the same elements are indicated through the same reference numerals.

In FIG. 3 a further example is shown in which in some particularly long sections 16 and 17 a channel or similar support element 26 is also foreseen that collaborates for the correct arrangement of the chain 11. As can be imagined, in this way, in the withdrawn position, the cable carrier chain 11 is curved back in the opposite direction to the withdrawing direction and rests upon the channel or support element 26 overlapping the various sections 16, 17. When withdrawal occurs, i.e. the telescopic group 12 extends lengthways, the chain is made to fit increasingly well on the portions of the channel 26, without any sliding, so that it is carried with ease and without problems. Of course, the channel 26 can in turn also be carried on rollers 27 and advances without any sliding.

FIG. 4 shows a further third example in which the section 17 becomes fixed and the remaining sections 16 and 14 are mobile and extractable. In this case, the second fixed point is shown at 18 in the fixed base section 17, whereas the first fixed point 13 remains in the first mobile extractable section 14.

The tensioning retaining element 21 of the cable carrier chain becomes a shaft 28 fixed to the fixed section 17 that carries at its upper free end a support and containment element, like a pad, a bearing element, a takeup pulley 25, as represented in the example that is free to rotate and support the cable carrier chain 11. The chain 11 is thus free to slide around the roller 25 in whatever mutual position of the sections 17, 16 and 14 whilst still being supported. It must also be observed that the presence of the shaft 28, possibly in the form of a plate, determines a sliding bearing element of the cable carrier chain 11 when the various sections 17, 16 and 14, for example forming part of a crane arm, are lowered and moved between one of the inclined operative positions represented and a position tending towards the horizontal or even at a negative angle, as stated previously.

This is a particularly simplified solution that is valid for a telescopic arm with two mobile sections and a fixed section.

In such a way, the width of the cable carrier chain 11 is fully exploited and an arrangement is created that prevents any possible breaking, thanks to the presence of the tensioning retaining element 21 of the cable carrier chain inside the structure of the telescopic group. This element indeed acts upon the chain itself in whatever position of the first extended mobile section, for example the one indicated with 14, of the telescopic group 12.

In general, in all of the examples the mobile parts and the fixed parts for support and containment of the chain and the chain itself are removable and act as a freely removable crankcase.

Small chains with respect to those generally used can thus be used since they are supported in every position of their operation. The need to have a chain equipped with self-support is avoided and unhelpful sliding is avoided.

The absence of harmful sliding or stresses on the chain is achieved both in conditions of homogeneous and non-homogeneous withdrawal.

In all of the cases considered, a better distribution of the forces in play in the cable carrier chain is achieved avoiding stresses in the ascending vertical position, such as dangerous combined bending and compressive stress, which are always problematic and can at times even lead to the cable carrier chain breaking.

The cable carrier chain arrangement according to the present invention is particularly simple and useful thanks to its arrangement and to the collaborating positioning of the parts of which it consists.

1. Improved cable carrier chain arrangement (11) in ascending vertical position inserted in telescopic groups (12) with two or more fixed and mobile sections that contains and guides flexible pipings or similar, in which it is foreseen that the cable carrier chain (11) has, at opposite ends, a first fixed point (13), integral with a mobile section (14, 16, 17) of the telescopic group (12), and a second fixed point (18, 20), integral with a fixed section (15) or with at least one mobile section (17) of the telescopic group, characterised in that a tensioning retaining element (21) of the cable carrier chain is foreseen acting on the chain itself in whatever position of the mobile section (14) of the telescopic group on which the first fixed point (13) is arranged.

2. Improved cable carrier chain arrangement according to claim 1, characterised in that said first fixed point (13) is arranged in a low zone with respect to the horizontal position of telescopic group (12), whereas said second fixed point (18) is arranged in an upper zone of said mobile section (17) with respect to the horizontal of said telescopic group (12).

3. Improved cable carrier chain arrangement according to claim 1, characterised in that said tensioning retaining element (21) of the cable carrier chain (11) comprises an elastic element (22).

4. Improved cable carrier chain arrangement according to claim 1 or 3, characterised in that said elastic element comprises a spring (22) arranged between said chain and at least one withdrawable mobile section of said telescopic group (12).

5. Improved cable carrier chain arrangement according to claim 4, characterised in that at one end of said spring (22) arranged at said cable carrier chain (11) a takeup pulley (25) is arranged free to rotate and support the cable carrier chain (11).

6. Improved cable carrier chain arrangement according to claim 1, characterised in that said tensioning retaining element (21) of the cable carrier chain (11) comprises a shaft integral with a first section (17) that is fixed and that carries, at an upper end thereof, an element for supporting and containing the cable carrier chain (11) , said first fixed point (13) being integral with a first mobile section (14) of the telescopic group (12) that comprises just two mobile sections (14, 16).

7. Improved cable carrier chain arrangement according to claim 1, characterised in that support elements (26) are arranged integral with some mobile sections (16, 17) of said telescopic group (12).

8. Improved cable carrier chain arrangement according to claim 7, characterised in that said support elements consist of a channel (26).

9. Improved cable carrier chain arrangement according to claim 7, characterised in that said support elements are rollers (27) and a channel (26).
